(19) United States
(12) Patent Application Publication
(10) Pub. No.: US 2010/0101660 A1
(43) Pub. Date: Apr. 29, 2010

(54) CHANNEL SWITCHING SYSTEM

(75) Inventors: Ken Kitamura, Otsu-shi (JP); Toshihito Kido, Matsubara-shi (JP); Shinji Harada, Sakai-shi (JP); Kenichi Miyata, Amagasaki-shi (JP); Yasuhiro Sando, Amagasaki-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/528,750

(22) PCT Filed: Feb. 21, 2008
(86) PCT No.: PCT/JP2008/052959

§ 371 Date: Aug. 26, 2009

(30) Foreign Application Priority Data
Feb. 27, 2007 (JP) 2007-047041

(51) Int. Cl. G05D 11/00; F16K 31/64; G01N 35/08

(52) U.S. Cl. 137/109; 137/825; 137/833; 137/828

(57) ABSTRACT

A channel switching system includes two microvalves i.e. a first valve (stopper valve) and a second valve (water retaining valve). The first valve is openable and closable, and the second valve is operable to block fluid flow by a surface tension force. Changing the first valve from an open state to a close state enables to switch the system from a condition that the fluid flows through the channel where the first valve is mounted by blocking the flow at the second valve by the surface tension force to a condition that the fluid flows through the channel where the second valve is mounted by releasing the system from the condition that the flow is blocked at the second valve by the surface tension force.

### TECHNICAL FIELD

The present invention relates to a channel switching system for switching between flow channels of a branching channel, and more particularly to a channel switching system capable of switching between flow channels using a microvalve.

### BACKGROUND ART

In recent years, there has been paid attention to μ-TAS (micro-Total Analysis System), wherein chemical analysis (test), chemical synthesis, and the like are conducted by using a miniaturized apparatus or technique by application of a micromachine technology. As compared with a conventional device, the miniaturized μ-TAS has advantages such as a reduced amount of a specimen, a shortened reaction time, or a reduced amount of a waste liquid. Applying the μ-TAS to the medical field is advantageous in reducing a burden to a patient because of a reduced amount of a sample (such as blood), and reducing a cost required for a test because of a reduced amount of a reagent. Also, since the amounts of a sample and a reagent are reduced, the reaction time can be remarkably shortened, and the test efficiency can be increased. Further, since the μ-TAS is superior in portability, an extended application of the μ-TAS to the medical field, environment analysis, and the like is expected.

In the μ-TAS (also called as “micro fluid system” considering that the system processes a fluid such as the specimen and the sample), a microvalve is an indispensable element. A microvalve in the μ-TAS is an element having a function substantially equivalent to the function of e.g. a switch in an integrated circuit. In view of this, integration on a chip is required. Also, in a system directed to a medical application, there is a demand for a disposable chip (a micro-chemical chip or a fluid chip) through which a sample such as blood is allowed to flow. In view of this, a demand for cost reduction has been increasing.

The conventional microvalves generally employ a system (e.g. see patent document 1) using a movable member such as an actuator or a diaphragm, and the structure and control of the system are complicated. As a result, production of the conventional microvalves has become cumbersome and costly, which has been a problem in practical use.

Patent document 1: JP Hei 7-158757A

### DISCLOSURE OF THE INVENTION

An object of the invention is to provide an easily producible and less costly channel switching system capable of switching a branching channel with a simplified arrangement and easy control.

To accomplish the above object, a channel switching system according to an aspect of the invention includes: a branching channel formed by branching a channel at a branching point; a drive source, disposed at a channel on an upstream side of the branching channel with respect to the branching point, for pushing a fluid toward a downstream side by a predetermined pressing force; a first valve, as a microvalve disposed at one of the channels branched out from the branching channel at the downstream side with respect to the branching point, operable to perform a closing operation to change the first valve from an open state that the fluid flows through the one channel to a close state that the fluid flow is blocked; and a second valve, as a microvalve disposed at the other of the channels branched out from the branching channel, operable to retain the fluid by a predetermined retention force to keep the fluid from flowing toward the downstream side by a surface tension force.

In the above arrangement, changing the first valve from an open state to a close state enables to switch the system from a condition that the fluid flows through the channel where the first valve is mounted by blocking the flow at the second valve by a surface tension force to a condition that the fluid flows through the channel where the second valve is mounted by releasing the system from the condition that the flow is blocked by the second valve. In other words, simply closing the first valve enables to switch the channel. This enables to perform an operation of switching the branching channel with a simplified arrangement and easy control. Thereby, production of the channel switching system is made easy, and cost reduction is realized.

These and other objects, features and advantages of the present invention will become more apparent upon reading of the following detailed description along with the accompanying drawings.

### BRIEF DESCRIPTION OF THE DRAWINGS

FIG. 1 is a schematic diagram showing an example of a basic arrangement of a channel switching system embodying the invention.

FIGS. 2A and 2B are enlarged views showing an example of a water retaining valve for use in the channel switching system, wherein FIG. 2A is a plan view and a side view of the water retaining valve, and FIG. 2B is a plan view and a side view of an example showing a state that the fluid flow is suspended in the water retaining valve shown in FIG. 2A.

FIGS. 3A and 3B are diagrams for describing an example of an operation of switching a branching channel to be performed by the channel switching system, wherein FIG. 3A shows how a fluid flows in an open state of a stopper valve, and FIG. 3B shows how a fluid flows in a close state of the stopper valve.

FIGS. 4A, 4B, 4C, 4D, and 4E are respectively plan views showing a modification of the water retaining valve.

FIG. 5 is a plan view and a side view of a modification of the water retaining valve shown in FIGS. 2A and 2B.

FIG. 6 is a plan view or a side view of a modification of the stopper valve shown in FIG. 1.

FIGS. 7A and 7B each is a plan view and a side view of a modification of the stopper valve.

FIGS. 8A and 8B are each a plan view and a side view of a modification of the stopper valve.

FIGS. 9A and 9B are each a plan view and a side view of a modification of the stopper valve.

FIGS. 10A and 10B are each a plan view and a side view of a modification of the stopper valve.

FIG. 11 is a schematic diagram for describing an actual application example of the channel switching system.

FIG. 12 is a diagram showing a modification of the channel switching system.

FIG. 13 is a diagram showing another modification of the channel switching system.

FIG. 14 is a plan view of a modification of the water retaining valve.

FIG. 15 is a plan view of another modification of the water retaining valve.

### BEST MODE FOR CARRYING OUT THE INVENTION

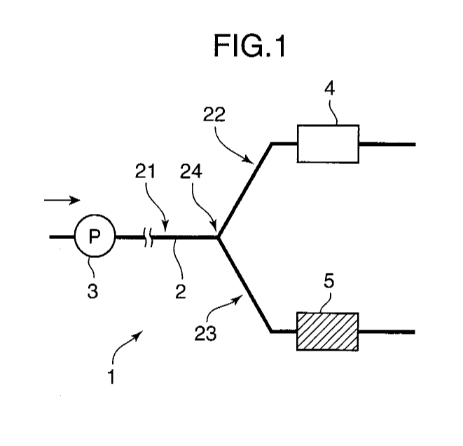

FIG. 1 is a schematic diagram showing an example of a basic arrangement of a channel switching system embodying the invention. A channel switching system 1 is a microsystem for switching between flow channels of a branching channel, and includes a branching channel 2, a drive source 3, a water retaining valve 4 (second valve), and a stopper valve 5 (first valve). The branching channel 2 is a channel formed by branching a flow channel into plural channels at a branching point, and having e.g. a rectangular (or a circular) shape in cross section. The branching channel 2 is constituted of an upstream channel 21 (a channel) corresponding to an upstream portion with respect to the branching point, a branching portion 24 corresponding to the branching point of the upstream channel 21, and downstream channels 22 and 23 (other channel and one channel) corresponding to channel portions posterior to the branching portion 24 i.e. downstream portions with respect to the branching portion 24 (branching point).

The drive source 3 is attached (connected) to the upstream channel 21, and is adapted to push a fluid toward downstream with a predetermined pressing force. The drive source 3 is e.g. a syringe pump or a diaphragm-driven micro-pump.

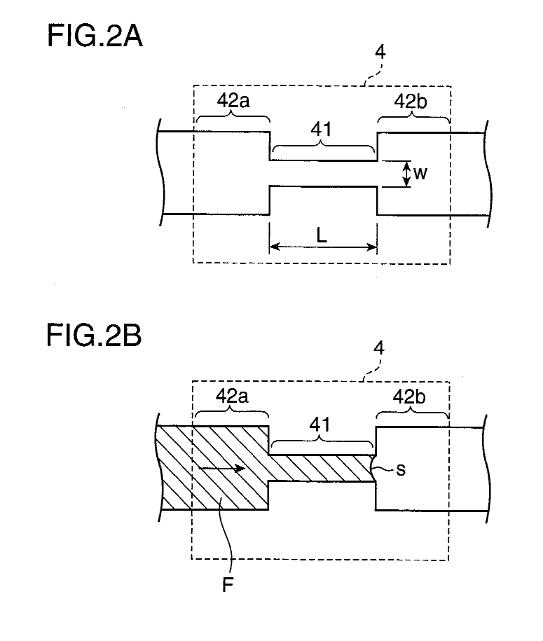

The water retaining valve 4 is provided at one of the branched channels, in this example, at the downstream channel 22. The water retaining valve 4 is a microvalve constructed to suspend flow of a fluid (retain the fluid while keeping the fluid from flowing downstream) utilizing a surface tension force (water retainability) of the fluid, or start flowing the fluid by releasing the system from a flow suspended state by the surface tension force. FIGS. 2A and 2B are partially enlarged views showing essential parts of an example of the water retaining valve 4. FIG. 2A is a plan view (also a side view) of the water retaining valve 4, and FIG. 2B is a plan view (side view) showing a state that the fluid flow is suspended at the water retaining valve 4.

As shown in FIG. 2A, the water retaining valve 4 includes a narrow portion 41 where the downstream channel 22 is partially narrowed, and having e.g. a constant channel width (or channel diameter) smaller than the inner width (or inner diameter) of the downstream channel 22, or having a cross sectional area smaller than the cross sectional area of the downstream channel 22. Specifically, the water retaining valve 4 includes the narrow portion 41, and channel portions 42a and 42b corresponding to parts of the downstream channel 22 formed adjacent to both ends (upstream end and downstream end of the narrow portion 41) in the channel direction of the narrow portion 41. The narrow portion 41 is formed substantially at a middle position in a direction of cross section of the channel, and has a rectangular (e.g. square) shape in cross section of the channel. The width L of the channel direction (flow direction) of the narrow portion 41 is in the range from e.g. 25 μm to 100 μm, and the width W (vertical size or horizontal size or inner diameter) of the narrow portion 41 in the direction of cross section of the channel is in the range from e.g. 16 μm to 70 μm. The channel width of the channel portion 42a, 42b is not necessarily identical to the channel width of the downstream channel 22. In other words, the water retaining valve 4 may be constituted of the narrow portion 41, and two channel portions (which are also included in the downstream channel 22) adjacent to the narrow portion 41, and having a channel width larger than the channel width of the narrow portion 41. The cross section of the narrow portion 41 may have e.g. a circular shape, in place of the rectangular shape.

As shown in FIG. 2B, the water retaining valve 4 is constructed in such a manner that a fluid F (indicated by the hatched portion) that has flowed through the upstream channel 21 and the downstream channel 22, and reached the water retaining valve 4, for instance, is brought to a state that the fluid F is retained in the narrow portion 41 with a predetermined pressure (called as a retention force) to keep the fluid F from flowing downstream (toward the channel portion 42b) by a surface tension force, in other words, a state (balanced state) that a force for flowing the fluid F and a force for retaining the fluid F are balanced to each other. Specifically, in the narrow portion 41, the shape (surface shape of retained water) of a distal end S of the fluid F in contact with the air has a concave shape as shown in FIG. 2B by a surface tension force, and the water retaining valve 4 is brought to a state that the fluid flow is suspended (the fluid F is stagnated). It should be noted that the term “suspended” is not limited to a meaning that the fluid F is completely unmoved, but embraces a case that the distal end S of the fluid F is e.g. slightly moved back and forth in the channel in a condition that the fluid F does not flow downstream from the narrow portion 41, in other words, a case that the entirety of the fluid F stays in the narrow portion 41, although the fluid F is slightly moved.

The surface shape of retained water may be e.g. a convex shape or a flat shape, as well as the concave shape, because a force (negative force) acting in a direction opposite to the case shown in FIG. 2B may be acted depending on the shape of a site where the balance is kept. Also, a phenomenon called “water retaining state” that the fluid F e.g. water is retained occurs in a condition that a relation: the surface tension force of a liquid (fluid F)>the surface tension force of a solid matter (an orifice wall of the narrow portion 41) is satisfied. In view of this, it can be said that flow of the fluid F in the water retaining valve 4 (narrow portion 41) is suspended due to water retainability resulting from a surface tension force. Although the term “water retainability” includes a word “water”, the fluid F (liquid) is not limited to “water”. In other words, the fluid F may be a liquid other than water. As far as the fluid F is allowed to flow in a channel, and flow of the fluid F can be suspended by a surface tension force, any material including a liquid containing e.g. a gas or a solid may be used. A fluorine material may be coated on a wall surface of the channel where the water retaining valve 4 is mounted to satisfy the above relation on the surface tension force.

As far as the fluid F is pushed from upstream side (or sucked from downstream side) by a pressure (a pressing force by the drive source 3) equal to or smaller than the retention force, as described above, the fluid F is suspended in the narrow portion 41. However, in the case where the fluid F is pushed (or sucked) by a pressure (a pressing force) larger than the retention force, and a pressure difference between the pressure (called as a first inner pressure P1) of the channel portion 42a, and the pressure (called as a second inner pressure P2) of the channel portion 42b i.e. a value (a pressure difference: P1−P2) obtained by subtracting the second inner pressure P2 from the first inner pressure P1 exceeds the retention force, in other words, the aforementioned force balanced state is lost, the fluid F is allowed to flow through the water retaining valve 4 in the downstream direction shown by the arrow in FIG. 2B. Once the fluid F is allowed to flow through the water retaining valve 4, the fluid F flows through the water retaining valve 4 with a pressing force smaller than the retention force. Thus, the flow is secured.

The stopper valve 5 is provided at the other channel out of the branched channels, in this example, at the downstream channel 23. The stopper valve 5 is a microvalve constructed to perform a closing operation to change the first valve from an open state that the fluid F flows through the downstream channel 23 to a close state that the flow of the fluid F is blocked. The arrangement and the operation of the stopper valve 5 will be described later.

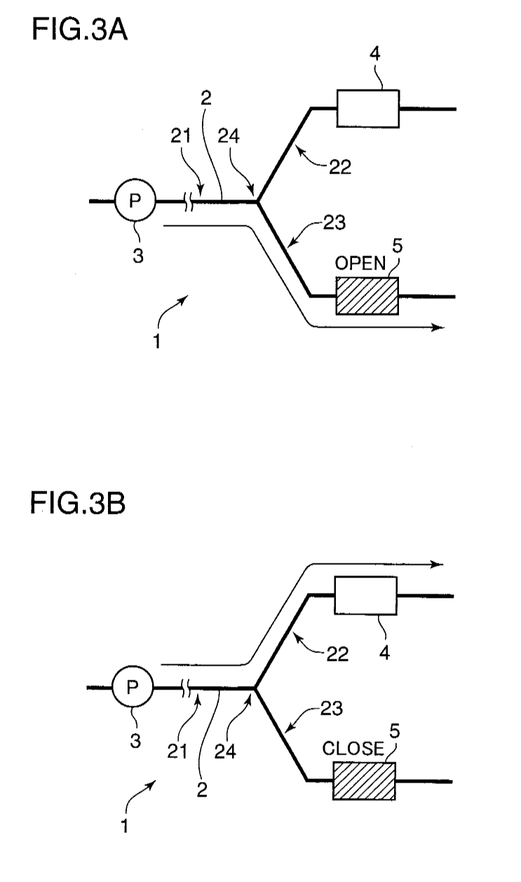

FIGS. 3A and 3B are diagrams for describing an example of an operation of switching the branching channel to be performed by the channel switching system 1, wherein FIG. 3A shows how a fluid flows in an open state of the stopper valve 5, and FIG. 3B shows how a fluid flows in a close state of the stopper valve 5. First, as shown in FIG. 3A, in the case where the fluid F is pushed downstream through the upstream channel 21 by the drive source 3 when the stopper valve 5 is in an open state, as far as the pressure difference (P1−P2) in the water retaining valve 4 does not exceed the retention force in the narrow portion 41, the fluid F is blocked by the water retaining valve 4. Thereby, the fluid F is allowed to flow from the upstream channel 21 to the downstream channel 23 via the branching portion 24 (in other words, the fluid F is allowed to flow downstream while passing the stopper valve 5). When a channel switching operation is performed by the channel switching system 1, the stopper valve 5 is normally kept in an open state.

On the other hand, as shown in FIG. 3B, in the case where a closing operation of the stopper valve 5 is performed, in other words, the stopper valve 5 is changed from an open state to a close state, the inner pressures of the upstream channel 21 and the downstream channels 22 and 23 are increased, and the pressure difference (P1−P2) between the first inner pressure P1 and the second inner pressure P2 exceeds the retention force of the narrow portion 41. As a result, the fluid F whose flow has been suspended at the water retaining valve 4 is allowed to flow through the water retaining valve 4. Thereby, the fluid F is allowed to flow from the upstream channel 21 to the downstream channel 22 via the branching portion 24.

An operation of switching the branching channel to be performed by the channel switching system 1 changes a first condition that the stopper valve 5 is brought to an open state, and the fluid F is allowed to flow from the upstream channel 21 to the downstream channel 23 via the branching portion 24 by the drive source 3 by retaining the fluid F at the water retaining valve 4 by the retention force. Specifically, the switching operation realizes switching from the first condition to a second condition that the fluid F is allowed to flow from the upstream channel 21 to the downstream channel 22 via the branching portion 24 by the drive source 3 by flowing the fluid F downstream from the water retaining valve 4 by a pressing force larger than the retention force, by an easy operation of closing the stopper valve 5.

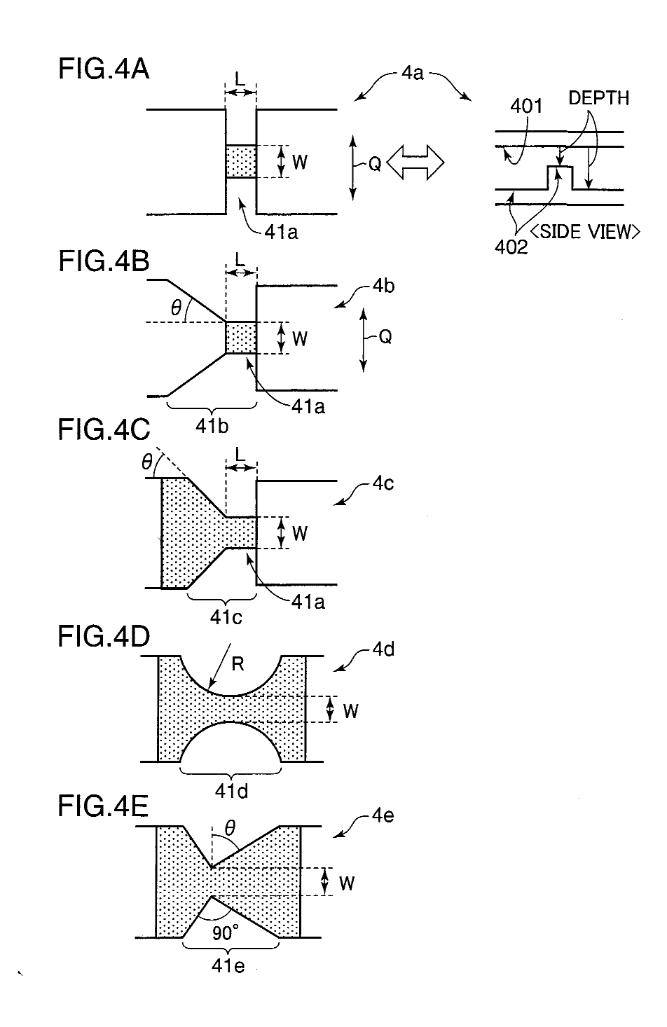

The water retaining valve 4 is not limited to the one shown in FIGS. 2A and 2B, but may be any shape as shown in e.g. FIGS. 4A through 4E in plan view. Specifically, a water retaining valve 4a shown in FIG. 4A is a modification of FIGS. 2A and 2B. The depth (distance from an upper surface 401 to a bottom surface 402) of a narrow portion 41a is set smaller than the depths of channels (channel portions 42a and 42b) anterior and posterior to the narrow portion 41a in a direction orthogonal to the narrowing direction Q of the narrow portion 41a.

A water retaining valve 4b shown in FIG. 4B is constructed in such a manner that the upstream channel portion 42a of the water retaining valve 4a is tapered with a taper angle θ, with the channel width thereof being gradually reduced toward a flow inlet of the narrow portion 41a. Alternatively, a portion including the tapered portion and the narrow portion 41a may be formed into a narrow portion 41b of the water retaining valve 4b.

A water retaining valve 4c shown in FIG. 4C is a modification of the water retaining valve 4b. The water retaining valve 4c is constructed in such a manner that the depth of a portion (indicated by the shaded portion) including a narrow portion 41a and a tapered portion upstream of the narrow portion 41 is set smaller than the depth of the other portion. In this modification, a portion indicated by the reference numeral 41c may be formed into the narrow portion 41c.

A water retaining valve 4d shown in FIG. 4D has a so-called “throat portion” substantially in the middle thereof, wherein the channel width is reduced by two opposing arc portions having a radius R. In this modification, a portion defined by the arc portions may be formed into a narrow portion 41d, and the depth of a portion (indicated by the shaded portion) including the narrow portion 41d may be set smaller than the depth of the other portion.

A water retaining valve 4e shown in FIG. 4E has a wedge-shaped cutaway portion having a vertex angle of e.g. 90 degrees (right angle), in other words, a shape, wherein the channel width is linearly reduced from upstream toward downstream, and is linearly increased from a smallest channel width portion (throat portion), specifically, a shape constituted of a gradually reducing tapered portion and a gradually increasing tapered portion. In this example, the taper angle of the reducing tapered portion is set larger (with a large gradient) than the taper angle of the increasing tapered portion. In this modification, a portion indicated by the reference numeral 41e may be formed into a narrow portion 41e.

In this example, the widths L and W in FIGS. 4A through 4E are respectively e.g. in the range from 25 μm to 100 μm and in the range from 16 μm to 70 μm in the similar manner as the case shown in FIGS. 2A and 2B. The depths of the narrow portions (the shaded portions) are each e.g. 40 μm, and the depths of the other portions are each e.g. 300 μm. The radius R of the water retaining valve 4d is in the range from e.g. 25 μm to 50 μm.

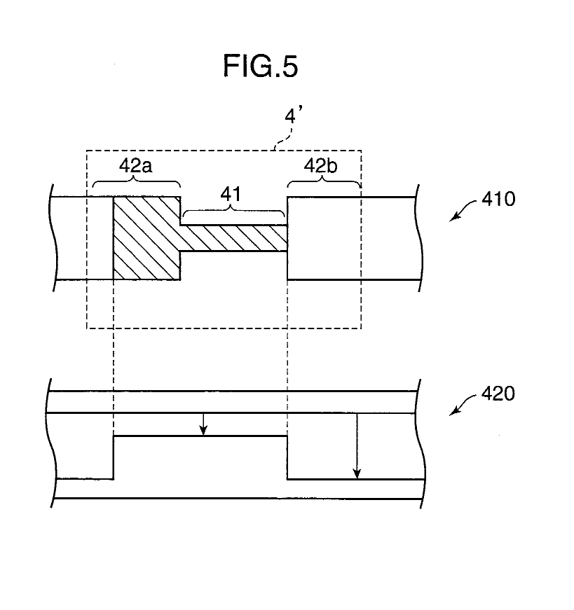

The angle θ shown in FIGS. 4B, 4C, and 4E is in the range from e.g. 30° to 60°. Similarly to the above, the water retaining valve 4 shown in FIGS. 2A and 2B may be formed into e.g. a water retaining valve 4′ shown in a plan view 410 and a side view 420 in FIG. 5 in such a manner that the depth of a portion (the hatched portion) constituted of a narrow portion 41 and a part of a channel portion 42a is set smaller than the depth of the other portion. Alternatively, a narrow portion may be formed by optionally combining the narrow portions 41a through 41e. It is needless to say that any other shape and size of the water retaining valve may be applied.

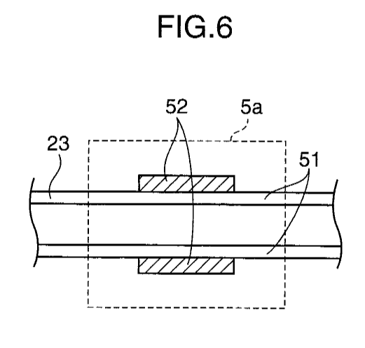

Next, an arrangement and an operation of the stopper valve 5 are described. As described above, as far as the stopper valve 5 is capable of bringing the channel from an open state to a close state, various arrangements may be proposed. For instance, as shown in FIG. 6, a stopper valve 5a may include predetermined cooling means e.g. a Peltier element 52 mounted on a member 51 constituting a downstream channel 23 to cool (freeze) and solidify the fluid F in the downstream channel 23 by the Peltier element 52. For instance, in the case where the fluid F contains water as a primary component, cooling the fluid F to a temperature lower than about 0° C. enables to solidify the fluid F (e.g. turn the fluid F into ice) in the downstream channel 23 at a position where the Peltier element 52 is mounted. Thereby, the fluid flow in the downstream channel 23 is blocked, and the stopper valve 5a is brought to a close state.

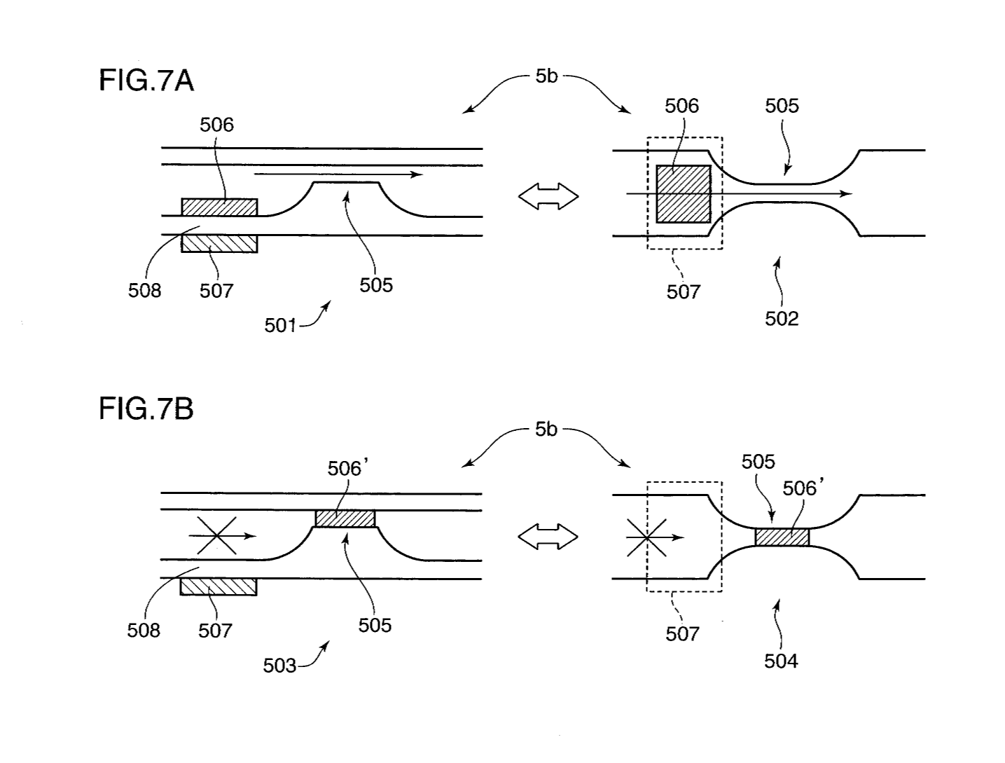

Alternatively, the stopper valve 5 may be a stopper valve 5b having the arrangement as shown in e.g. FIGS. 7A and 7B. FIG. 7A is a side view (a diagram indicated by the reference numeral 501) and a plan view (a diagram indicated by the reference numeral 502) of the stopper valve 5b in an open state. FIG. 7A is a side view (a diagram indicated by the reference numeral 503) and a plan view (a diagram indicated by the reference numeral 504) of the stopper valve 5b in a close state.

The stopper valve 5b has a portion where the cross section of the channel is reduced e.g. a narrow portion 505 where the downstream channel 23 is partially narrowed. A solid matter 506 is coated or adhered on e.g. an inner wall (position where flow of the fluid F to the narrow portion 505 is not obstructed) of the upstream channel with respect to the narrow portion 505. The solid matter 506 is e.g. a paraffin wax which is melted by being heated (the fluidity is increased). Predetermined heating means e.g. a heater 507 is provided at the site where the solid matter 506 is placed i.e. on the outer wall of the channel opposing to the solid matter 506 in a state that the heater 507 is mounted on a part 508 constituting the downstream channel 23 in contact with the part 508 to heat the solid matter 506.

As the solid matter 506 is heated into a melted state by the heater 507, the melted matter 506 migrates downstream along with the fluid F. When the melted matter 506 is migrated downstream beyond a heating area (see the dotted frames in the diagrams 502 and 504) of the heater 507, the temperature of the melted matter 506 is lowered and solidified into a solid matter 506′ at the narrow portion 505. Thereby, the fluid flow in the narrow portion 505 is blocked by the solid matter 506′ (the solid matter 506 which has been melted and then solidified), or the solid matter 506′ clogs the narrow portion 505, whereby the stopper valve 5b is brought to a close state. In order to properly perform the closing operation of the stopper valve 5b, it is necessary to set a relation between the solid matter 506 (the quantity, the kind of material, or the shape of the solid matter 506), the amount of heat (the kind or the output of the heater 507) to be applied to the solid matter 506, and the migrating distance of the solid matter 506 from the placed position of the solid matter 506 to the narrow portion 505 in a well-balanced state, in other words, obtain an optimal value based on e.g. an actual measurement result to be obtained in advance or the like.

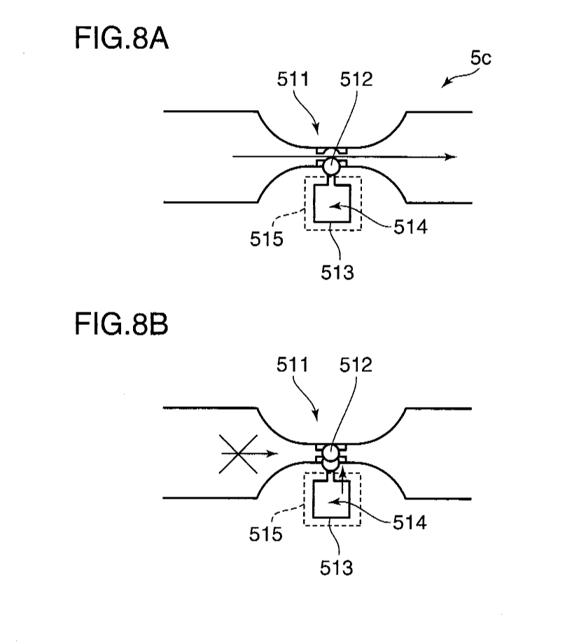

Alternatively, the stopper valve 5 may be a stopper valve 5c having the arrangement as shown in e.g. FIGS. 8A and 8B. FIGS. 8A and 8B are a side view or a plan view of the stopper valve 5c in an open state and a close state, respectively. Similarly to the above, the stopper valve 5c has a portion where the cross section of the channel is reduced e.g. a narrow portion 511 where the downstream channel 23 is partially narrowed. A glass-made spherical member 512 is mounted in a side portion of the narrow portion 511. The spherical member 512 is not limited to a glass member, but may be made of e.g. a resin or a metal. The shape of the spherical member 512 is not limited to a spherical shape, but any shape such as a cylindrical column shape, a circular conical shape, a prismatic shape, or a pyramidal shape may be employed.

A pressure chamber 513 is provided on the opposite side of the channel (downstream channel 23) with respect to the spherical member 512. The pressure chamber 513 is filled with e.g. a liquid 514. Predetermined heating means e.g. a heater 515 is mounted on the pressure chamber 513. When the pressure chamber 513 is heated by the heater 515, the liquid 514 is vaporized, and the inner pressure of the pressure chamber 513 is increased. Increasing the inner pressure of the pressure chamber 513 pushes the spherical member 512, and as shown in FIG. 8B, the spherical member 512 is shifted to the interior of the channel. Shifting the spherical member 512 into the channel blocks the fluid flow through the downstream channel 23, whereby the stopper valve 5c is brought to a close state. Alternatively, a gas may be filled in the pressure chamber 513, in place of the liquid 514. The modification is advantageous in increasing the inner pressure of the pressure chamber 513 by thermal expansion of the gas.

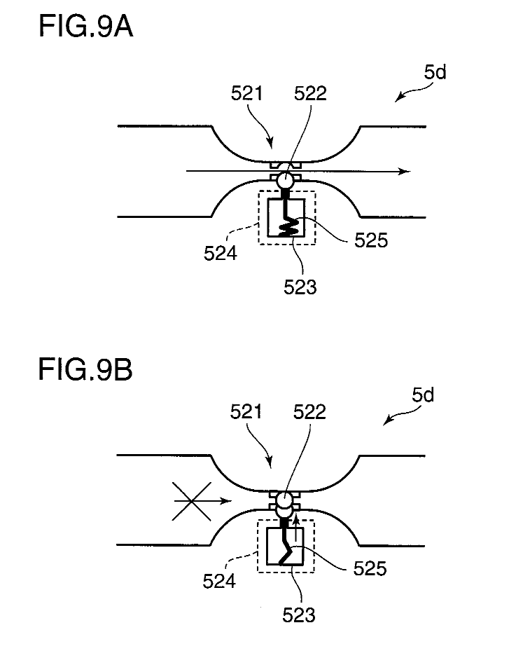

The stopper valve 5 may be a stopper valve 5d having the arrangement as shown in e.g. FIGS. 9A and 9B, which is a modification of the stopper valve 5c. FIGS. 9A and 9B are a side view or a plan view of the stopper valve 5d in an open state and a close state, respectively. Similarly to the above, the stopper valve 5d has a narrow portion 521, and a spherical member 522 similar to the above is mounted in a side portion of the narrow portion 521. A valve housing chamber 523 is provided on the opposite side of the channel with respect to the spherical member 522. A heater 524 is mounted on the valve housing chamber 523. An expandable member (expandable/contractable member) 525 made of a heat expandable shape memory alloy e.g. Ti—Ni-based alloy is provided in the valve housing chamber 523.

The expandable member 525 has a predetermined shape e.g. a linear shape (in this example, a base end of the expandable member 525 has a helical shape), and one end of the expandable member 525 is connected (or contactable) with the spherical member 522. For instance, if the expandable member 525 in a contracted state as shown in FIG. 9A is heated by the heater 524, the expandable member 525 is deformed into e.g. its original shape, and is brought to an expanded state as shown in FIG. 9B. Then, the spherical member 522 is migrated through the channel by the expandable member 525 in an expanded state, and the fluid flow through the downstream channel 23 is blocked, whereby the stopper valve 5d is brought to a close state. The expandable member 525 and the spherical member 522 may serve as a so-called “valve” for closing the channel. Alternatively, a shape memory polymer to be described later may be used in place of a shape memory alloy.

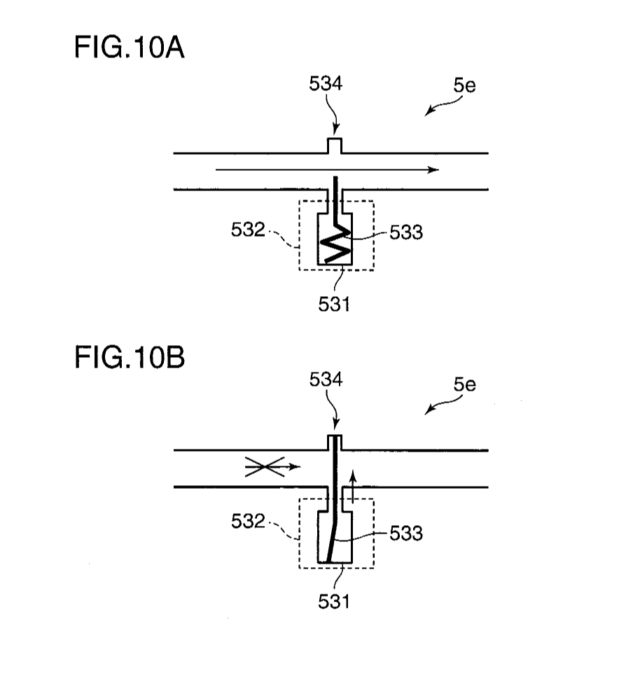

The stopper valve 5 may be a stopper valve 5e having the arrangement as shown in e.g. FIGS. 10A and 10B. FIGS. 10A and 10B are a side view or a plan view of the stopper valve 5e in an open state and a close state, respectively. Similarly to the above, the stopper valve 5e has a valve housing chamber 531 on the opposite side of the channel (downstream channel 23). A heater 532 is mounted on the valve housing chamber 531. An expandable member 533 made of a heat expandable shape memory polymer is provided in the valve housing chamber 531.

When the expandable member 533 shown in the state of FIG. 10A is heated by the heater 532, for instance, the expandable member 533 is deformed into its original shape, and is brought to an expanded state as shown in FIG. 10B. Then, the fluid flow through the downstream channel 23 is blocked by one end of the expandable member 533 in an expanded state, whereby the stopper valve 5e is brought to a close state. Alternatively, a concave engaging portion 534 is formed in a wall of the downstream channel 23 at a position opposite to the position where the expandable member 533 is provided, and the distal end of the expandable member 533 is received (engaged) in the engaging portion 534. This arrangement enables to securely block the fluid flow through the downstream channel 23 by the expandable member 533 in an expanded state. Alternatively, the aforementioned shape memory alloy may be used in place of the shape memory polymer.

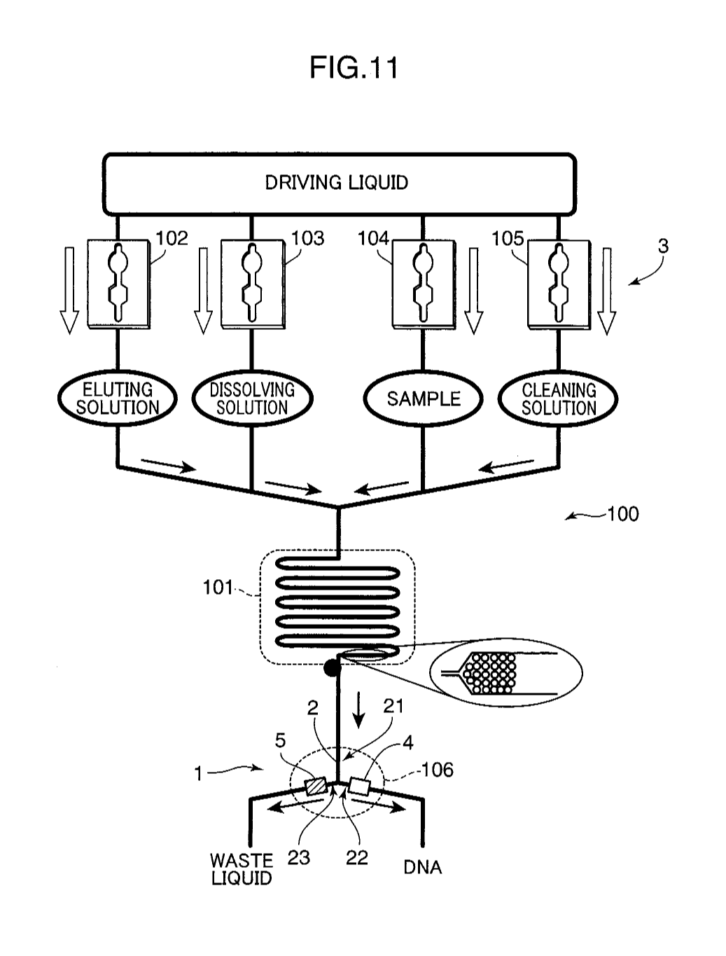

The channel switching system 1 is applied to e.g. an analyzing system 100 as shown in FIG. 11. The analyzing system 100 is adapted to extract nucleic acid (DNA or RNA) from a sample such as blood. The analyzing system 100 includes a cell dissolving section 101, in which multiple glass beads are movably placed in a predetermined passage (pipe arrangement). The analyzing system 100 further includes four liquid reservoirs at an upstream side thereof with respect to the cell dissolving section 101. The four liquid reservoirs are adapted to store an eluting solution, a dissolving solution, a sample, and a cleaning solution, respectively. Examples of the eluting solution are water, Tris-buffer, and TE (Tris-EDTA) buffer. An example of the dissolving solution is a mixed solution of guanidinium hydrochloride, ethylene diamine tetra acetate (EDTA), polyethylene glycol (PEG), and Tris hydrochloride (Tris-HCL). Examples of the cleaning solution are ethanol, a mixed solution of ethanol and water, and a mixed solution of ethanol, water, and sodium chloride.

The analyzing system 100 is constructed in such a manner that the liquids are pushed toward the downstream-side cell dissolving section 101 by a driving liquid (e.g. water) activated by micro-pumps 102 through 105, respectively. A branching channel switching section 106 for switching the channel between a channel for discharging a waste liquid, and a channel for discharging a liquid containing DNA is provided at a downstream channel with respect to the cell dissolving section 101. The branching channel 2, the water retaining valve 4, and the stopper valve 5 in the channel switching system 1 correspond to the branching channel switching section 106; and the drive source 3 in the channel switching system 1 corresponds to the micro-pumps 102 through 105.

First, the dissolving solution and the sample are allowed to flow into the cell dissolving section 101, and the mixed solution is stirred in the cell dissolving section 101, which is heated by a heater or a like device. Thereby, cell membranes and the like in the sample are dissolved, and DNA eluted from the sample is adsorbed to the beads. Next, the cleaning solution is allowed to flow to wash away unwanted substances (e.g. cell membranes broken during elution of DNA). During the washing operation, the waste liquid is allowed to flow through the downstream channel 23, and discharged through the stopper valve 5 in a constantly close state. Subsequently, water is allowed to flow, with the cell dissolving section 101 being heated by the heater or the like, to elute the DNA adsorbed to the beads into the eluting solution, and the eluting solution containing the DNA is allowed to flow to the branching channel switching section 106. In performing this operation, switching the channel by the branching channel switching section 106 i.e. changing the stopper valve 5 from an open state to a close state to close the stopper valve 5 enables to discharge the liquid containing the eluted DNA through the downstream channel 22 via the water retaining valve 4 (in other words, extract the DNA).

As described above, the channel switching section 1 includes the branching channel 2 formed by branching a channel (upstream channel 21) at a branching point (branching portion 24); the drive source 3, disposed at a channel on an upstream side of the branching channel 2 with respect to the branching point, for pushing a fluid toward a downstream side by a predetermined pressing force; the stopper valve 5 (first valve), as a microvalve disposed at one of the branched channels i.e. the downstream channel 23, which is branched out from the branching channel at the downstream side with respect to the branching point, and operable to perform a closing operation to change the stopper valve 5 from an open state that the fluid flows through the one channel to a close state that the fluid flow is blocked; and the water retaining valve 4 (second valve), as a microvalve disposed at the other of the branched channels i.e. the downstream channel 22, which has a narrow portion 41 where the downstream channel 22 is partially narrowed, and is operable to retain the fluid by a predetermined retention force to keep the fluid from flowing toward the downstream side at the narrow portion 41 by a surface tension force.

In response to a closing operation of the stopper valve 5, the system is switched from a first condition that the stopper valve 5 is in an open state, and the fluid is allowed to flow from the upstream channel to the downstream channel 23 via the branching point by the drive source 3 by retaining the fluid at the water retaining valve 4 by the retention force to a second condition that the fluid is allowed to flow from the upstream channel 21 to the downstream channel 22 via the branching point by the drive source by flowing the fluid from the water retaining valve 4 toward the downstream side by the pressing force larger than the retention force.

In this way, changing the stopper valve 5 from an open state to a close state enables to switch the system from a condition that the fluid flows through the channel where the stopper valve 5 is mounted by blocking the flow at the water retaining valve 4 by the surface tension force to a condition that the fluid flows through the channel where the water retaining valve 4 is mounted by releasing the system from the condition that the flow is blocked at the water retaining valve 4. In other words, simply closing the stopper valve 5 enables to switch the channel. This enables to perform an operation of switching the branching channel with a simplified arrangement and easy control. Thereby, the easily producible and less costly channel switching system 1 can be realized.

The water retaining valve 4 includes the narrow portion 41, a first partial channel (channel portion 42a) adjacent to an upstream end of the narrow portion 41, and a second partial channel (channel portion 42b) adjacent to a downstream end of the narrow portion 41, wherein the first partial channel and the second partial channel are a part of the downstream channel 22. The fluid is allowed to flow from the second valve toward the downstream side when a pressure difference (P1−P2) between a first inner pressure P1 of the first partial channel and a second inner pressure P2 of the second partial channel exceeds the retention force, wherein the first inner pressure and the second inner pressure are derived from the pressing force. This enables to realize the water retaining valve 4 capable of retaining the fluid by the predetermined retention force to keep the fluid from flowing toward the downstream side at the narrow portion 41 by the surface tension force, with a simplified arrangement.

The narrow portion 41 (41a) is formed into a shape having a predetermined channel width smaller than the channel width of the downstream channel 22. This enables to simplify the arrangement of the narrow portion 41, and facilitate fabricating the water retaining valve 4.

The narrow portion (41b, 41c, 41d, 41e) is formed into a tapered shape or an arc shape. This enables to simplify the arrangement of the narrow portion 41, and facilitate fabricating the water retaining valve 4.

The water retaining valve 4 is formed into a shape that the depth of the narrow portion or a part of the narrow portion and/or a part of the other channel near the narrow portion is set smaller than the depth of the other portion of the branching channel in a direction orthogonal to the narrowing direction Q of the narrow portion (see the shaded portions in FIGS. 4A through 4E and the hatched portion in FIG. 5). This enables to easily fabricate the water retaining valve 4 capable of securely retaining the fluid to keep the fluid from flowing toward the downstream side by the surface tension force, with a simplified arrangement.

The stopper valve 5 is provided with solidifying means (the Peltier element 52 shown in FIG. 6) for solidifying (e.g. freezing) the fluid in the one channel, and the closing operation is performed by solidifying the fluid by the solidifying means. This enables to easily realize the stopper valve 5 with a simplified arrangement of solidifying the liquid in the channel.

The stopper valve 5 includes the narrow portion 505 where the downstream channel 23 is partially narrowed; the solid matter 506 disposed at the upstream side of the narrow portion 505 in the one channel, the solid matter 506 being melted by being heated, and solidified by being cooled; and the heater 507 for heating the solid matter 506, and a closing operation of the stopper valve 5 is performed by heating the solid matter 506 by the heater 507 to melt the solid matter 506, and allowing the melted matter 506 to flow into the solid matter 506′ to a position of the narrow portion 505 along with the fluid flowing through the one channel. This enables to easily realize the stopper valve 5 with a simplified arrangement of heating the solid matter 506 in the channel.

The stopper valve 5 includes migrating means (e.g. the pressure chamber 513, the liquid 514, and the heater 515 in FIGS. 8A and 8B; the valve housing chamber 523, the expandable member 525, and the heater 524 in FIGS. 9A and 9B; or the expandable member 533 as a blocking member, and the heater 532 in FIGS. 10A and 10B), which is operable to migrate a predetermined blocking member (the spherical member 512, 522, or a part of the expandable member 533 in the channel) for blocking the fluid flowing through the one channel (downstream channel 23) inside the one channel, and a closing operation of the stopper valve 5 is performed by migrating the blocking member inside the one channel by the migrating means. This enables to easily realize the stopper valve 5 with a simplified arrangement of migrating the blocking member inside the channel.

The migrating means includes a chamber (pressure chamber 513) filled with a liquid or a gas; and heating means (heater 515) for heating the chamber, and the blocking member is allowed to migrate inside the one channel by an inner pressure of the chamber, the inner pressure being increased by heating the chamber by the heating means. This enables to easily migrate the blocking member (spherical member 512) inside the one channel with a simplified arrangement of heating the chamber.

The migrating means includes the expandable member 525 (533) which is expanded by a heat; and heating means (heater 524) (heater 532 in the case of the expandable member 533) for heating the expandable member 525, and the blocking member is allowed to migrate inside the one channel by heating the expandable member by the heating means to expand the expandable member. This enables to easily migrate the blocking member inside the one channel with a simplified arrangement of heating the expandable member.

The expandable member 525, 533 is made of a shape memory alloy or a shape memory polymer. This enables to easily produce an expandable member operable to be expanded by a heat, with use of a shape memory alloy or a shape memory polymer.

In the foregoing, an embodiment of the invention has been described. The invention is not limited to the above, but the following modifications are applicable.

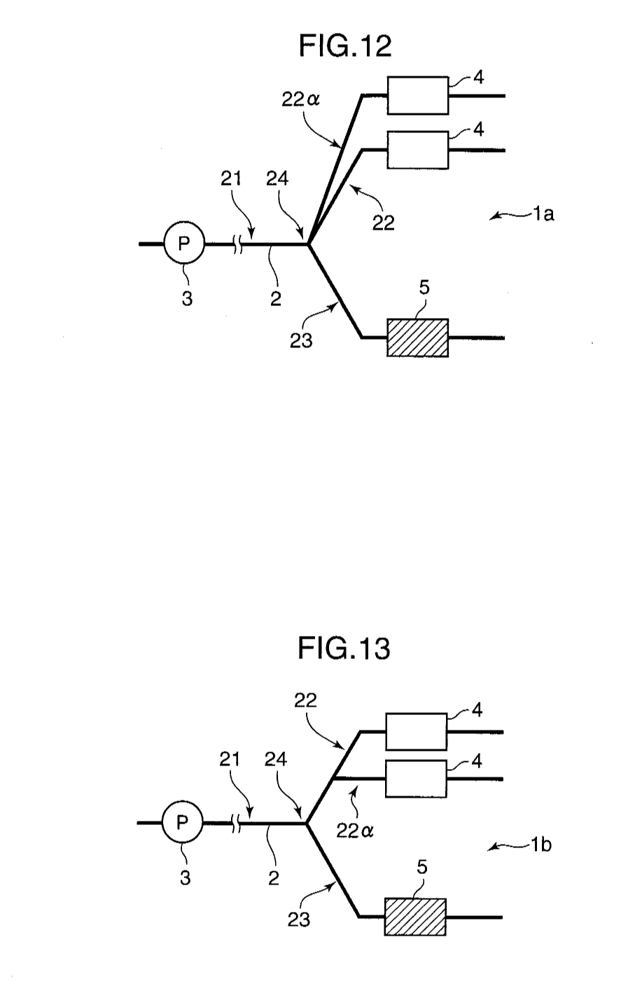

(A) The channel switching system 1 in this embodiment has a feature that, as shown in FIG. 1, the branching channel 2 is branched into two channels at the branching portion 24 as a branching point, the stopper valve 5 is mounted on one of the two downstream channels i.e. the downstream channel 23, and the water retaining valve 4 is mounted on the other of the two downstream channels i.e. the downstream channel 22. The invention is not limited to the above. For instance, as shown in FIG. 12, a channel switching system la may be constructed in such a manner that a branching channel 2 is branched into three channels at a branching portion 24 as a branching point, a stopper valve 5 is mounted on one of the three downstream channels i.e. a downstream channel 23, and water retaining valves 4 are mounted on the other ones (downstream channels 22 and 22α) of the three downstream channels, respectively.

In the above modification, when the stopper valve 5 is in an open state, a fluid F is allowed to flow through the downstream channel 23. When the stopper valve 5 is closed, the system is released from a condition that the flow is suspended by the water retaining valves 4, and the fluid F is allowed to flow through the downstream channels 22 and 22α. The number of branching i.e. the number of water retaining valves 4 and downstream channels corresponding to the water retaining valves 4 may be larger than three. In the case where a channel is branched into three or more channels, assuming that the downstream channel 23 (where the stopper valve 5 is mounted) is defined as one channel, the remaining two downstream channels 22 and 22α(where the water retaining valves 4 are mounted) are generically defined as the other channel. In this case, a single stopper valve 5 (and a single downstream channel 23) is provided, considering a difficulty in matching the timing of performing a closing operation. Alternatively, plural stopper valves 5 (and plural downstream channels 23) may be provided.

(B) Alternatively, a channel switching system 1b shown in FIG. 13 may be provided, in place of the channel switching system 1. Specifically, there is proposed an arrangement, wherein a channel is branched into two channels at a branching portion 24, and then a downstream channel 22 is connected to downstream channels 22α and water retaining valves 4, in other words, the downstream channel 22 is branched into two sub channels, and water retaining valves 4 are respectively mounted on the sub channels.

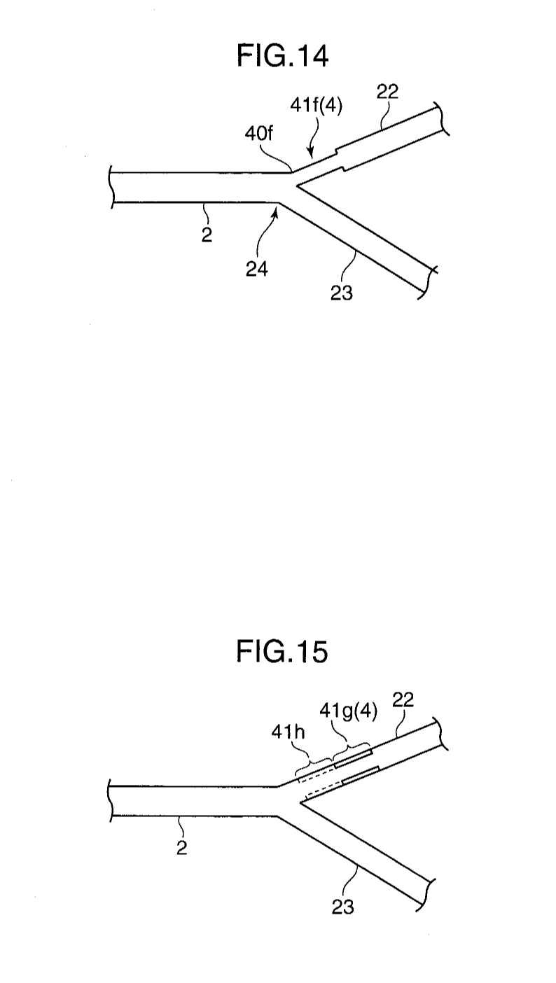

(C) FIG. 14 is a plan view of a modification of the water retaining valve 4. Concerning the arrangement of the water retaining valve 4, FIGS. 2A and 2B (FIGS. 4A through 4E) show the arrangement provided with the narrow portion 41, and the channel portions 42a and 42b adjacent to the upstream end and the downstream end of the narrow portion 41. Alternatively, as shown in FIG. 14, an upstream end 410f of a narrow portion 41f may be connected with a branching portion 24, in place of the arrangement that the narrow portion 41 is formed at an intermediate portion of the downstream channel 22.

(D) FIG. 15 is a plan view of another modification of the water retaining valve 4. In the foregoing embodiment, a narrow portion is formed as means for securing a retention force at the water retaining valve 4 to keep the fluid from flowing downstream by a surface tension force. Alternatively, as shown in FIG. 15, a water repellent portion 41g may be formed at an appropriate site on an inner surface of a downstream channel 22 to secure the retention force, in place of forming the narrow portion. The water repellent portion 41g is a portion formed by partially subjecting the inner surface of the downstream channel 22 to a water repellent treatment, and is an area having a large contact angle (e.g. 90° or more) with respect to a fluid flowing through the channel. Increasing the water repellency at an area having a large contact angle enables to secure the retention force. Thus, the modification enables to provide a function similar to the water retaining valve 4 described in the embodiment.

The water repellent portion 41g has a larger retention force, as the relative difference in contact angle between the water repellent portion 41g and an upstream area of the water repellent portion 41g is increased. In view of this, in FIG. 15, a hydrophilic portion 41h having a smaller contact angle is formed on an upstream area of the water repellent portion 41g. In this modification, the hydrophilic portion 41h is formed solely on an upstream area of the water repellent portion 41g. Alternatively, the entirety of the downstream channel 22, or the entirety of a channel including the branching channel 2 and the downstream channel 23 may be subjected to a hydrophilic treatment. Exemplified materials of the water repellent portion 41g are fluorine-based materials such as polypropylene and Teflon (registered trademark). Exemplified materials of the hydrophilic portion 41h are a hydrophilic polymer solution containing polyethylene, polyethylene imine, or polyvinyl alcohol; and a photocatalytically active material such as titanium oxide.

The foregoing embodiment and/or modifications mainly embrace the invention having the following arrangements.

A channel switching system according to an aspect of the invention includes a branching channel formed by branching a channel at a branching point; a drive source, disposed at a channel on an upstream side of the branching channel with respect to the branching point, for pushing a fluid toward a downstream side by a predetermined pressing force; a first valve, as a microvalve disposed at one of the channels branched out from the branching channel at the downstream side with respect to the branching point, operable to perform a closing operation to change the first valve from an open state that the fluid flows through the one channel to a close state that the fluid flow is blocked; and a second valve, as a microvalve disposed at the other of the channels branched out from the branching channel, operable to retain the fluid by a predetermined retention force to keep the fluid from flowing toward the downstream side by a surface tension force.

A channel switching system according to another aspect of the invention includes a branching channel formed by branching a channel at a branching point; a drive source, disposed at a channel on an upstream side of the branching channel with respect to the branching point, for pushing a fluid toward a downstream side by a predetermined pressing force; a first valve, as a microvalve disposed at one of the channels branched out from the branching channel at the downstream side with respect to the branching point, operable to perform a closing operation to change the first valve from an open state that the fluid flows through the one channel to a close state that the fluid flow is blocked; and a second valve, as a microvalve disposed at the other of the channels branched out from the branching channel, operable to retain the fluid by a predetermined retention force to keep the fluid from flowing toward the downstream side by a surface tension force, wherein in response to the closing operation of the first valve, the system is switched from a first condition that the first valve is in an open state, and the fluid is allowed to flow from the upstream channel to the one channel via the branching point by the drive source by retaining the fluid at the second valve by the retention force to a second condition that the fluid is allowed to flow from the upstream channel to the other channel via the branching point by the drive source by flowing the fluid from the second valve toward the downstream side by the pressing force larger than the retention force.

In the above arrangements, in response to the closing operation of the first valve, the system is switched from the first condition that the first valve is in an open state, and the fluid is allowed to flow from the upstream channel to the one channel via the branching point by the drive source by retaining the fluid at the second valve by the retention force to the second condition that the fluid is allowed to flow from the upstream channel to the other channel via the branching point by the drive source by flowing the fluid from the second valve toward the downstream side by the pressing force larger than the retention force.

In this way, changing the first valve from the open state to the close state enables to switch the system from the condition that the fluid flows through the channel (channel in the open state before the first valve is changed from the open state to the close state) where the first valve is mounted by blocking the flow at the second valve by the surface tension force to the condition that the fluid flows through the channel where the second valve is mounted by releasing the system from the condition that the flow is blocked at the second valve by the surface tension force. In other words, simply closing the first valve enables to switch the channel. This enables to perform an operation of switching the branching channel with a simplified arrangement and easy control. Thereby, the easily producible and less costly channel switching system can be realized.

In the above arrangement, preferably, the second valve may include a narrow portion where the other channel is partially narrowed. In this arrangement, preferably, the second valve may include the narrow portion, a first partial channel adjacent to an upstream end of the narrow portion, and a second partial channel adjacent to a downstream end of the narrow portion, the first partial channel and the second partial channel being a part of the other channel, and the fluid may be allowed to flow from the second valve toward the downstream side when a pressure difference between a first inner pressure of the first partial channel, and a second inner pressure of the second partial channel exceeds the retention force, the first inner pressure and the second inner pressure being derived from the pressing force.

The above arrangement enables to realize the second valve capable of retaining the fluid by the predetermined retention force to keep the fluid from flowing toward the downstream side at the narrow portion by the surface tension force, with a simplified arrangement.

In the above arrangement, preferably, the narrow portion may be formed into a shape having a predetermined channel width. This enables to simplify the arrangement of the narrow portion, and facilitate fabricating the second valve.

In the above arrangement, preferably, the narrow portion may be formed into a tapered shape or an arc shape. This enables to simplify the arrangement of the narrow portion, and facilitate fabricating the second valve.

In the above arrangement, preferably, the second valve may be formed into a shape that the depth of the narrow portion or a part of the narrow portion and/or a part of the other channel near the narrow portion is set smaller than the depth of the other portion of the branching channel in a direction orthogonal to the narrowing direction of the narrow portion. This enables to easily fabricate the second valve capable of securely retaining the fluid to keep the fluid from flowing toward the downstream side by the surface tension force, with a simplified arrangement.

In the above arrangement, preferably, the second valve may include a water repellent portion formed by partially subjecting the other channel to a water repellent treatment. This enables to fabricate the second valve capable of retaining the fluid by the predetermined retention force to keep the fluid from flowing toward the downstream side by the surface tension force, without forming a narrow portion.

In the above case, preferably, a part or a whole of the other channel other than the water repellent portion may be subjected to a hydrophilic treatment. This arrangement enables to increase the retention force of the water repellent portion.

In the above arrangement, preferably, the first valve may include solidifying means for solidifying the fluid in the one channel, and the first valve may perform the closing operation by solidifying the fluid by the solidifying means. This arrangement enables to easily realize the first valve for closing the channel by a simplified arrangement of solidifying the fluid in the channel.

In the above arrangement, preferably, the first valve may include a narrow portion where the one channel is partially narrowed, a solid matter disposed at the upstream side of the narrow portion in the one channel, the solid matter being melted by being heated and solidified by being cooled, and heating means for heating the solid matter, and the first valve may perform the closing operation by heating the solid matter by the heating means to melt the solid matter, and allowing the melted matter to flow to a position of the narrow portion along with the fluid flowing through the one channel to solidify the melted matter. This enables to easily realize the first valve for closing the channel with a simplified arrangement of heating the solid matter in the channel.

In the above arrangement, preferably, the first valve may include migrating means operable to migrate a predetermined blocking member for blocking the fluid flowing through the one channel inside the one channel, and the first valve may perform the closing operation by migrating the blocking member inside the one channel by the migrating means. This enables to easily realize the first valve for closing the channel with a simplified arrangement of migrating the blocking member inside the channel.

In the above arrangement, preferably, the migrating means may include a chamber filled with a liquid or a gas, and heating means for heating the chamber, and the blocking member may be migrated inside the one channel by an inner pressure of the chamber, the inner pressure being increased by heating the chamber by the heating means. This enables to easily realize the arrangement of migrating the blocking member inside the one channel with a simplified arrangement of heating the chamber.

In the above arrangement, preferably, the migrating means may include an expandable member which is expanded by a heat, and heating means for heating the expandable member, and the blocking member may be migrated inside the one channel by heating the expandable member by the heating means to expand the expandable member. This enables to easily realize the arrangement of migrating the blocking member inside the one channel with a simplified arrangement of heating the expandable member.

In the above arrangement, preferably, the expandable member may be made of a shape memory alloy or a shape memory polymer. This enables to easily produce an expandable member operable to be expanded by a heat, with use of a shape memory alloy or a shape memory polymer.

1. A channel switching system comprising:
a branching channel formed by branching a channel at a branching point;
a drive source, disposed at a channel on an upstream side of the branching channel with respect to the branching point, for pushing a fluid toward a downstream side by a predetermined pressing force;
a first valve, as a microvalve disposed at one of the channels branched out from the branching channel at the downstream side with respect to the branching point, operable to perform a closing operation to change the first valve from an open state that the fluid flows through the one channel to a close state that the fluid flow is blocked; and
a second valve, as a microvalve disposed at the other of the channels branched out from the branching channel, operable to retain the fluid by a predetermined retention force to keep the fluid from flowing toward the downstream side by a surface tension force.

2. The channel switching system according to claim 1, wherein
the second valve includes a narrow portion where the other channel is partially narrowed.

3. The channel switching system according to claim 2, wherein
the second valve includes the narrow portion, a first partial channel adjacent to an upstream end of the narrow portion, and a second partial channel adjacent to a downstream end of the narrow portion, the first partial channel and the second partial channel being a part of the other channel, and
the fluid is allowed to flow from the second valve toward the downstream side when a pressure difference between a first inner pressure of the first partial channel, and a second inner pressure of the second partial channel exceeds the retention force, the first inner pressure and the second inner pressure being derived from the pressing force.

4. The channel switching system according to claim 2, wherein
the narrow portion is formed into a shape having a predetermined channel width.

5. The channel switching system according to claim 2, wherein
the narrow portion is formed into a tapered shape or an arc shape.

6. The channel switching system according to claim 2, wherein
the second valve is formed into a shape that the depth of the narrow portion or a part of the narrow portion and/or a part of the other channel near the narrow portion is set smaller than the depth of the other portion of the branching channel in a direction orthogonal to the narrowing direction of the narrow portion.

7. The channel switching system according to claim 1, wherein
the second valve includes a water repellent portion formed by partially subjecting the other channel to a water repellent treatment.

8. The channel switching system according to claim 7, wherein
a part or a whole of the other channel other than the water repellent portion is subjected to a hydrophilic treatment.

9-14. (canceled)

15. A channel switching system comprising:
a branching channel formed by branching a channel at a branching point;
a drive source, disposed at a channel on an upstream side of the branching channel with respect to the branching point, for pushing a fluid toward a downstream side by a predetermined pressing force;
a first valve, as a microvalve disposed at one of the channels branched out from the branching channel at the downstream side with respect to the branching point, operable to perform a closing operation to change the first valve from an open state that the fluid flows through the one channel to a close state that the fluid flow is blocked; and
a second valve, as a microvalve disposed at the other of the channels branched out from the branching channel, operable to retain the fluid by a predetermined retention force to keep the fluid from flowing toward the downstream side by a surface tension force, wherein
in response to the closing operation of the first valve, the system is switched from a first condition that the first valve is brought to the open state, and the fluid is allowed to flow from the upstream channel to the one channel via the branching point by the drive source by retaining the fluid at the second valve by the retention force to a second condition that the fluid is allowed to flow from the upstream channel to the other channel via the branching point by the drive source by flowing the fluid from the second valve toward the downstream side by the pressing force larger than the retention force.

16. The channel switching system according to claim 15, wherein
the second valve includes a narrow portion where the other channel is partially narrowed.

17. The channel switching system according to claim 16, wherein
the second valve includes the narrow portion, a first partial channel adjacent to an upstream end of the narrow portion, and a second partial channel adjacent to a downstream end of the narrow portion, the first partial channel and the second partial channel being a part of the other channel, and
the fluid is allowed to flow from the second valve toward the downstream side when a pressure difference between a first inner pressure of the first partial channel, and a second inner pressure of the second partial channel exceeds the retention force, the first inner pressure and the second inner pressure being derived from the pressing force.

18. The channel switching system according to claim 16, wherein
the narrow portion is formed into a shape having a predetermined channel width.

19. The channel switching system according to claim 16, wherein
the narrow portion is formed into a tapered shape or an arc shape.

20. The channel switching system according to claim 16, wherein
the second valve is formed into a shape that the depth of the narrow portion or a part of the narrow portion and/or a part of the other channel near the narrow portion is set smaller than the depth of the other portion of the branching channel in a direction orthogonal to the narrowing direction of the narrow portion.

21. The channel switching system according to claim 15, wherein
the second valve includes a water repellent portion formed by partially subjecting the other channel to a water repellent treatment.

22. The channel switching system according to claim 15, wherein
a part or a whole of the other channel other than the water repellent portion is subjected to a hydrophilic treatment.

23-28. (canceled)

29. The channel switching system according to claim 1, wherein
the first valve includes a solidifying mechanism for solidifying the fluid in the one channel, and
the first valve performs the closing operation by solidifying the fluid by the solidifying mechanism.

30. The channel switching system according to claim 1, wherein
the first valve includes:
a narrow portion where the one channel is partially narrowed;
a solid matter disposed at the upstream side of the narrow portion in the one channel, the solid matter being melted by being heated and solidified by being cooled; and
a heating member for heating the solid matter, and
the first valve performs the closing operation by heating the solid matter by the heating member to melt the solid matter, and allowing the melted matter to flow to a position of the narrow portion along with the fluid flowing through the one channel to solidify the melted matter.

31. The channel switching system according to claim 1, wherein
the first valve includes:
a migrating mechanism operable to migrate a predetermined blocking member for blocking the fluid flowing through the one channel inside the one channel, and
the first valve performs the closing operation by migrating the blocking member inside the one channel by the migrating mechanism.

32. The channel switching system according to claim 31, wherein
the migrating mechanism includes:
a chamber filled with a liquid or a gas; and
a heating member for heating the chamber, and
the blocking member is migrated inside the one channel by an inner pressure of the chamber, the inner pressure being increased by heating the chamber by the heating member.

33. The channel switching system according to claim 31, wherein
the migrating mechanism includes:
an expandable member which is expanded by a heat; and
a heating member for heating the expandable member, and
the blocking member is migrated inside the one channel by heating the expandable member by the heating member to expand the expandable member.

34. The channel switching system according to claim 33, wherein the expandable member is made of a shape memory alloy or a shape memory polymer.

35. The channel switching system according claim 15, wherein
the first valve includes solidifying mechanism for solidifying the fluid in the one channel, and
the first valve performs the closing operation by solidifying the fluid by the solidifying mechanism.

36. The channel switching system according to claim 15, wherein
the first valve includes:
a narrow portion where the one channel is partially narrowed;
a solid matter disposed at the upstream side of the narrow portion in the one channel, the solid matter being melted by being heated and solidified by being cooled; and
a heating member for heating the solid matter, and
the first valve performs the closing operation by heating the solid matter by the heating member to melt the solid matter, and allowing the melted matter to flow to a position of the narrow portion along with the fluid flowing through the one channel to solidify the melted matter.

37. The channel switching system according to claim 15, wherein
the first valve includes:
a migrating mechanism operable to migrate a predetermined blocking member for blocking the fluid flowing through the one channel inside the one channel, and
the first valve performs the closing operation by migrating the blocking member inside the one channel by the migrating mechanism.

38. The channel switching system according to claim 37, wherein
the migrating mechanism includes:
a chamber filled with a liquid or a gas; and
a heating member for heating the chamber, and
the blocking member is migrated inside the one channel by an inner pressure of the chamber, the inner pressure being increased by heating the chamber by the heating member.

39. The channel switching system according to claim 37, wherein
the migrating mechanism includes:
an expandable member which is expanded by a heat; and
a heating member for heating the expandable member, and
the blocking member is migrated inside the one channel by heating the expandable member by the heating member to expand the expandable member.

40. The channel switching system according to claim 39, wherein the expandable member is made of a shape memory alloy or a shape memory polymer.
